(19) United States
(12) Patent Application Publication
(10) Pub. No.: US 2003/0036497 A1
(43) Pub. Date: Feb. 20, 2003

(54) Disintegration adjuncts for use in detergent and cleaning compositions

(75) Inventors: Scott D. Manske, Davidson, NC (US); Harald Bauer, Kerpen (DE); Josef Holz, Erftstadt (DE); Gunther Schimmel, Erftstadt (DE)

Correspondence Address: CLARIANT CORPORATION, INTELLECTUAL PROPERTY DEPARTMENT, 4000 MONROE ROAD, CHARLOTTE, NC, 28205, US

(73) Assignee: Clariant International, Ltd.

(21) Appl. No.: 09/888,960

(22) Filed: Jun. 25, 2001

(51) Int. Cl. C11D 17/00

(52) U.S. Cl. 510/446; 510/447; 510/511

(57) ABSTRACT

Disintegration adjunct particles for use in detergents and cleaning agents include an alkali layer silicate and a water swellable compound. The adjunct particles provide increased disintegration of solid particles in detergents and cleaning agents by facilitating the penetration of water into the adjunct particles and hence increase the expansion rate of the water swellable compound. The adjunct particles may also include a readily soluble, non-bleaching active detergent substance to thereby increase the disintegration rate.

### FIELD OF THE INVENTION

The invention deals with adjunct particles of alkali layer silicates and water swellable compounds.

### BACKGROUND OF THE INVENTION

EP 0 650 926 describes the roll compacting of crystallized, layered sodium disilicate with the addition of hardening agents such as water, silica brine, silica gel, tensing agent, water glass and homo- and copolymers of maleic acid and acrylic acid, intended to render the granulate more resistant to mechanical influences, for instance rubbing.

The use of homo- and copolymers of maleic acid and acrylic acid, particularly poly carboxylates of varying chain lengths, is known among experts to disperse dirt and builder particles in detergents and cleaning agents and supposed to delay precipitation of calcium carbonate. Generally, the expert is expecting to achieve a delayed granulate disintegration in the detergent solution by solidifying the granulate by increasing cohesion between the crystalline components of the granulate.

### SUMMARY

It was now determined that adjuncts of alkali layer silicates and water swellable or “super-absorbent” compounds can be used to advantage for disintegration of solid particles in detergents and cleaning agents, as for instance in tablets. Preferably, the water swellable compound is a polycarboxylate. The adjuncts may be formed by a variety of processing techniques, including, but not limited to, granulation, compaction, and extrusion to yield discrete particles or granules.

### DETAILED DESCRIPTION OF THE PREFERRED EMBODIMENTS

According to a preferred embodiment, the present invention is an adjunct comprising:

a) at least one alkali layer silicate; and

b) at least one water swellable component.

The alkali layer silicate is preferably crystalline layered sodium silicate of the formula NaMSiₓO₂ₓ₊₁ x yH₂O, whereby M represents sodium or hydrogen, x a number from 1.9 through 4, and y a number from 0 through 20. Alternatively, the alkali layer silicate is an alumina silicate.

As used herein, the term “adjunct” means two or more components processed to form discrete particles, with the majority of the particles containing each of the two or more components.

The ratio between component a) to component b) is 0.5 to 1 through 20 to 1, preferably 0.75 to 1 through 15 to 1, most preferably 1 to 1 through 10 to 1.

Preferably, the sodium silicates a) have x-values of 2, 3 or 4. Particularly preferred are sodium disilicates Na₂Si₂O₅ *yH₂O featuring y equal to 2. For sodium silicates a), mixtures could be employed.

In a preferred form, the crystalline layered of sodium disilicate a) are composed of changing percentage parts of the polymorphous phases alpha, beta, delta and epsilon combined. Commercially prepared products may also contain amorphous parts. Through the latter, in commercial products, x can be present in the odd numbered range as well. The preferred value is 1.9≦x≧2.2.

Preferred crystalline layered sodium silicate a) contain 0 to 40 weight-% alpha sodium disilicate, 0 to 40 weight-% beta sodium disilicate, 40 to 100 weight-% delta sodium disilicate, and 0 to 40 weight-% amorphous parts.

Particularly preferred crystalline layered sodium silicate a) contain 7 to 21 weight-% alpha sodium disilicate , 0 to 12 weight-% beta sodium disilicate, 65 to 95 weight-% delta sodium disilicate and 0 to 20 weight-% amorphous parts.

Particularly preferred are crystalline layered sodium silicate a) containing 80 to 100 weight-% delta sodium disilicate.

Crystalline layered sodium silicate a) containing 70 to 100 weight-% beta sodium disilicate can also be used in another preferred version.

The aforementioned alpha sodium disilicate corresponds to EP-B-0 164 514 described as Na-SKS-5, characterized by the x-ray diffraction data quoted there, and which are categorized as alpha-Na₂Si₂O₅. The x-ray diffraction diagrams are registered with the Joint Committee of Powder Diffraction Standards under the numbers 18-1241, 22-1397, 22-1397A, 19-1233, 19-1234 and 19-1237.

The aforementioned beta sodium disilicate corresponds to EP-B-0 164 514 described as Na-SKS-7, characterized by the x-ray diffraction data quoted there, and which are categorized as beta Na₂Si₂O₅. The x-ray diffraction diagrams are registered with the Joint Committee of Powder Diffraction Standards under the numbers 24-1123 and 29-1261.

The aforementioned delta sodium disilicate corresponds to EP-B-0 164 514 described as Na-SKS-6, characterized by the x-ray diffraction data quoted there, and which are categorized as delta Na₂Si₂O₅. The x-ray diffraction diagrams are registered with the Joint Committee of Powder Diffraction Standards under the number 22-1396.

In a preferred form, the crystalline layered sodium silicate a) contain additional cationic and/or anionic components. Cationic components are preferably alkaline metalloids and I or earth alkaline metal cationic combinations, and/or Fe, W, Mo, Ta, Pb, Al, Zn, Ti, V, Cr, Mn, Co and or Ni.

The preferred anionic components are aluminate, sulfate, fluoride, chloride, bromide, iodide, carbonate, hydrogen carbonate, nitrate, oxide hydrate, phosphate, and/or borate.

In an alternative preferred form, the crystalline layered sodium silicate a) contain, relative to the total SiO₂ content, up to 10 molecule-% Boron.

In a further alternative preferred form, the crystalline layered sodium silicate a) contain, relative to the total SiO₂ content, up to 20 molecule-% phosphor.

Particularly preferred also are hydrothermally produced sodium disilicate by the formula beta-hydrothermal-Na₂Si₂O₅, as described in patent specifications EPO559680, W09209526, U.S. Pat. No. 5,417,951, DE4102743 and EP0569365.

Particularly preferred also are the crystalline sodium and alkaline silicates and the hydrates thereof sold under the trademarks DB-1 and DB-2, by PQ Corp., and described in the following patents: EPO717722, WO9534506, U.S. Pat. No. 5,643,358, EP0727769, WO9601307, U.S. Pat. No. 5,739,098.

Particularly preferred as sodium layer silicate are the ones described in WO 009444.

Further preferred as sodium layer silicate are those described in EPO 550 048 and EP 0630 855.

Preferably, the alkaline layer silicate is employed in powder form. The preferred mean particle size measures 0.1 to 4000 μm, particularly preferred 10 to 500 μm, especially preferred 20 to 200 μm.

The at least one water swellable compound, component b), for use in the present invention may be any water swellable compound normally employed in the art of detergents. As used herein the phrase “water swellable” means a component which, when exposed to free or unbound water, expands readily to at least a multiple of its original volume. Such water swellable compounds include, but are not limited to, cellulosics, cellulose ether polymers, polycarboxylic acids, their derivatives and the salts thereof, and cross-linked polycarboxylic acids, their derivatives and the salts thereof. Preferably, the water swellable compound is a polycarboxylate or a mixture of polycarboxylates.

The polycarboxylates used as component b) facilitate disintegration. Suitable are such polycarboxylates, as generally contained in detergents and cleaning agents to serve as dispersant or as hardening agent for granulates.

Preferred polycarboxylates are poly acrylic acid of homo polymers, as these display particularly good qualities as dispersant. Preferred are poly acrylic acid-homo polymers featuring a neutralization degree of 0 to 70%.

In another version, a neutralization degree of up to 100 is preferred. Of importance also is the degree of integration. Particularly preferred as component b) are crosslinked copolymers of acrylic and maleic acid sold under the trademarks Acusol 771 and Acusol 772 by Rohm and Haas.

While not wishing to be bound by theory, it is believed that forming particles of at least one alkali layer silicate and at least one water swellable component provides a synergistic effect, in that the resultant particles having an amorphous or irregular morphology, or other structural characteristic which creates non-uniform channels or interstices within the particles. These non-uniform channels provide pathways through which water may penetrate the particles and contact the water swellable component.

Increasing the rate at which water contacts the water swellable component increases the expansion or “swell” rate of the particles and thus expedites the particles' disintegration, and hence, the disintegration of the detergent or cleaning agent.

To increase the mechanical hardness, for instance to combat mechanical rubbing, the adjunct can be fortified with hardening agents. Particularly preferred hardening agents are alkaline silicate, non ionic tensides (i.e., non ionic surfactants), anionic tensides, cationic tensides, poly carboxylate polymers, poly carboxylate copolymers, poly ethylene glycol, bentonite, hectorite and/or saponite.

Preferred alkali silicates are sodium- and potassium silicates, the watery solutions of which are also called water glass. Such substances are produced by dissolving solid water glass (piece water glass), spray dried water glass or directly by breaking down sand and sodium lye. Preferably, the molecular compositions of the water glasses are: Me₂O:SiO₂ equal 0.2:1 up to 1:1, with Me=Na, K and H₂O:SiO₂ equal 0.9:1 up to 250:1.

Among the non ionic tensides, preferred are alkyl alkoxylate, glucon amide, alkyl poly glycoside and/or amine oxides. Particularly preferred non ionic tensides are detergent and cleaning agents described hereinbelow.

Preferred anionic tensides are carboxylate, sulfonates and sulfates, particularly preferred (C₉-C₁₃)-alkyl benzol sulfonates, alpha olefin sulfonates, alkane sulfonates, esters of sulfonic acids, salts derived from alpha sulfonic acids, sulfuric acid mono ester of (C₁₂-C₁₈) fatty alcohols and soaps. Particularly preferred anionic tensides are detergent and cleaning agents described hereinbelow.

Preferred poly carboxylate polymers and copolymers are copolymers derived from acrylic acid and maleic acid respectively, alkaline salts thereof, preferably sodium and alkaline salts. The molecular weight of the homo polymers is preferably in the range of 1 000 up to 100 000 g/mol. The molecular weight of the copolymers is preferably in the range of 2 000 up to 200 000 g/mol., particularly preferred in the range of 50 000 up to 120 000 g/mol. Particularly preferred are acrylic acids/maleic acid copolymers having a molecular weight of 50 000 up to 100 000 g/mol. Preferred also are copolymers of acrylic acid or methacrylic acid with vinyl ethers, such as for instance, vinyl methyl ether, vinyl ester, ethylene, propylene and styrol.

Commercial products suitable for use in the present invention, include, but are not limited to Sokalan® CP 5 and PA 30 by BASF, Alcosperse® 175 or 177 by Alco and LMW 45 N and SP02 N by Norsohaas.

The cationic tensides are quaternary compounds (C₆-C₁₆)—, preferably (C₆-C₁₀)—N— of alkyl and alkenyl ammonia, in which the remaining N positions are substituted by methyl, hydroxy ethyl or the hydroxy propyl group.

Particularly preferred cationic tensides are detergents and cleaning agents described hereinbelow.

Preferred poly ethylene glycolates are those having a molecular weight of 1000-10 000 g/mol., particularly preferred 2 000 up to 8 000 g/mol.

Preferred as bentonite, hectorite and saponite are montmorillonite of the formula Naₓ[Al₄₋ₓMg(OH)Si₄O₁₀]*nH₂O with 0.1<x<20, preferably x equals 0.33 and n equals 4; hecatorite of the formula Naₓ[Mg₃₋ₓLiₓSi₄O₁₀]*nH₂O with 0.1<x<0.4 and 0<n<20, and saponite of the formula Naₓ[Mg₃(Si₄₋ₓAlₓ)₄O₁₀]*nH₂O with 0.1<x<0.4 and 0<n<20, preferably x equals 0.33 and n equals 1.

The adjuncts are produced by bringing components a) into contact with components b), followed by further mechanical treatment to form discrete particles, agglomerations, or cogranulates.

Bringing components a) and b) into contact can be carried out by any procedure that ensures sufficient contact among the components. Preferred are mixing and spraying techniques, with mixing techniques being particularly preferred. Preferred mixing systems are those employing paddle, ring layer- or plow share devices, for example the Free Fall Mixer manufactured by Lödige; or, the Eyrich-Mixer, Schugl-Mixer, Wirbelbett Mixer or Drum Mixer manufactured by Telschig.

Mixing cycles of 0.5 s up to 60 min. duration are preferred, with a 2 s to 15 min. duration being particularly preferred.

The step of bringing into contact components a) and b) can be carried out in any variation, provided thorough mixing of the components is guaranteed. It would, for instance be possible to pre mix part of the components and adding the remaining parts in the next step.

An important aspect of the invention is the subsequent mechanical treatment of components a) and b), resulting in fervent contact among components a) and b) and achieving the desired particle distribution.

The preferred sequence for the subsequent mechanical treatment is compacting, granulating, grinding/crushing and kernel fracturing.

During the compacting process, the powder to be compacted not only is pressed together by its own weight, but the individual particles can be also crushing each other. The preferred compacting process is press granulation, as for instance roll compacting, or formation of briquettes, especially preferring roller compacting.

The temperature of the materials during compacting should preferably be kept between 10 and 200° C., using external heating or cooling apparatus to regulate the desired temperature, or by allowing the energy released by the friction to adjust the temperature by itself. During compacting, the time of exposure to pressure only lasts for a fraction of a second, until the resulting sheets or Schülpen clumps are crushed by grinders of a special type and kernel fractured, if needed.

While continuously processing, the pieces exiting the roller compacting cycle are immediately crushed by grinders of a special type and, if needed, kernel fractured. Properly sized particles are removed and separated from the undersized and oversized particles, which are returned to either the compacting or grinding devices to run through the cycle again.

The preferred line pressure for roller compacting is between 2 and 200 kN/cm roller width, particularly preferred between 10 and 160 kN/cm roller width. These line pressure ranges may vary, depending on the particular roller compacting apparatus employed, and the fact that the area over which the material is actually exposed to the pressure varies during processing .

The point over which the highest pressure is exerted is in the area where the two concave rollers are coming closest together. The size of this area can only be estimated and is thus application specific. It is furthermore likely that through continued use the roller surface is eroding, and uniform distribution of pressure compromised. Based on the aforementioned preferred areas and a 1 cm application width, the resulting pressure is between 2 and 200 kN/cm², particularly preferred between 10 and 100 kN/cm². Suitable roller compactors are for instance available from Messrs. Hosokawa-Bepex and Alexanderwerk.

The grinding process serves to reduce the particle size of powders, of press granulates and to crush any clumps of material. Preferred apparatus for use in the grinding process include swing grinders, roller grinders, and pendulum roller grinders (for instance those available from Neuman & Esser), hammer grinders, impact grinders or air ray grinders (for instance those available from Hosokawa Alpine).

The material exiting from kernel fracturing is categorized by size into oversized, properly sized and undersized particles, preferably by visual screening and/or sifting. Most preferred is sifting. Suitable sifting devices are for instance available from Rhewum, Locker or Allgeier.

Preferably, processing of the adjuncts in the manner detailed above yields cogranulates or cocompactants of an average particle size of 200 to 2000 μm, preferably 400 to 900 μm. Also preferred is a ground granulate featuring an average particle size of 0.1 up to 300 μm, preferably 10 up to 200 μm.

Surprisingly it was has been determined that the adjuncts of the present invention, in combination with readily soluble detergent components, favorably affects disintegration of detergent and other cleaning agent solids.

Therefore, according to another preferred embodiment, a disintegration system for detergent and cleaning agent solids comprises:

1) at least one adjunct including:

a) at least one alkali silicate, and

b) at least one water swellable component, and

2) at least one readily soluble, active detergent substance.

The alkali layer silicate is preferably crystalline layered sodium silicate of the formula NaMSiₓO₂ₓ₊₁ x yH₂O, whereby M represents sodium or hydrogen, x a number from 1.9 through 4, and y a number from 0 through 20.

The addition of the readily soluble active detergent substance further aids in the disintegration of the particles by providing additional porosity and channels through which the water may reach the water swellable component.

Preferably, the at least one water swellable component is a polycarboxylate, while the at least one readily soluble, active detergent substance is non-bleaching. The ratio of component a) to component b) is 0.5 to 1 to 20 to 1; preferably, 0.75 to 1 to 15 to 1; and most preferably 1 to 1 up to 10 to 1. The weight ratios between component 1) to component 2) to component 3) are 0.5 to 1 to 0.5 to 20 to 1 to 60, preferably 0.75 to 1 to 0.75 to 10 to 1 to 40, most preferably 1 to 1 to 1 up to 9 to 1 to 20.

In this embodiment, components 1)a) and 1)b) are compacted or granulated according the method described above. Once the adjunct is formed, it is then added to component 2).

The readily soluble, non bleaching active detergent substance is preferably an alkaline or ammonia carbonate, -hydrogen carbonate, -carbonate-hydrogen carbonate salt mixture, meta silicate, spray dried silicate, -sulfates,-hydrogen sulfate, poly phosphate, dihydrogen phosphate, hydrogen phosphate, poly phosphate, pyro phosphate, borate, Borax, organic acids and salts thereof (for example citrates, acetates, formates, and ascorbates) or readily soluble organic compositions (for instance urea) and hydrates thereof.

Readily soluble material helps to maintain or increase porosity during the disintegration phase. Beneficial are substances possessing hydrating properties, particularly preferred are those whose crystal grid expands from crystal water infusion.

The readily soluble, non bleaching active detergent substances of have an average particle size of 0.1 to 4000 μm, preferably 10 to 500 μm, and most preferably 20 to 200 μm.

According to another preferred embodiment, an adjunct disintegration system for detergent and cleaning agent solids comprises:

1) Alkaline layer silicates a), and

2) at least one water swellable component b), and

3) at least one readily soluble, active detergent substance.

The alkali layer silicate is preferably crystalline layered sodium silicate of the formula NaMSiₓO₂ₓ₊₁ x yH₂O, whereby M represents sodium or hydrogen, x a number from 1.9 through 4, and y a number from 0 through 20. The readily soluble, active detergent substance is preferably non-bleaching.

In this embodiment, components 1), 2), and 3) are homogeneously mixed using any procedure commonly employed in the art and thereafter, compacted, granulated or extruded to form discrete particles.

The ratio between components 1) to component 2) is 0.5 to 1 to 20 to 1, preferably 0.75 to 1 to 15 to 1, most preferred 1 to 1 to 10 to 1. The ratio between component 1) to component 2) to component 3) is 0.5 to 1 to 0.5 to 20 to 1 to 60, preferably 0.75 to 1 to 0.75 to 10 to 1 to 40, most preferred 1 to 1 to 1 to 9 to 1 to 20.

According to another preferred embodiment, a detergent and/or cleaning agent contains at least one adjunct and/or disintegration system according to the invention.

These detergents are preferably complete detergents, compact complete detergents, compact detergents for colors, complete detergents of low concentration, specialty detergents, as for instance water softeners, stain removing salts, bleach booster, detergents for curtains, detergents for woolens, modular construction detergents and industrial detergents.

The preferred cleaning agents are automatic dishwasher detergent and automatic dishwasher rinsing agents. Silicates are preferred because of their dirt dispersing properties, high alkalinity and glass protecting qualities. Actions damaging to glasses are not only the build up of deposit layers, but also erosion occurring on the glass surface-both resulting in the well known unwanted clouding of glasses.

Preferred detergent and cleaning agents contain

a) 0.5 to 99 weight-% of adjunct according to the invention

b) ad 100 weight-% additional substances normally employed in the art of detergents and cleaning agents.

Preferred detergent and cleaning agents contain

a) 0.5 to 99 weight-% of adjunct according to the invention

b) 0.5 to 80 weight-%, preferably 1 to 70 weight-% of readily soluble, non bleaching active detergent substances

c) ad 100 weight-% additional substances normally employed in the art of detergents and cleaning agents.

Other special detergent and cleaning agents, for instance automatic dishwasher detergents contain 0.5 to 30 weight-% of adjuncts according to the invention.

Additional substances normally employed in the art of detergents and cleaning agents include, but are not limited to cobuilders, surface active substances, bleaching systems and/or pH regulators.

The cobuilders are preferably crystalline aluminum silicates, mono oligo or polymer or copolymer carbon acid and/or carboxylates, crystalline layered silicate, crystalline alkaline silicate without layer structure and I or x-ray amorphous alkali silicates.

The bleaching systems are preferably active chlorine based and/or organic or inorganic active oxygen based (for instance perborate, percarbonate, or percarbon acids), bleach activators (for instance TAED), bleach catalysts (for instance the catalysts according to DE19913995, WO9823531, WO0036061), and other non-bleaching cleaning agents, for example, enzymes for removal of discolorations[, and so forth].

The surface active substances are preferably anionic, cationic, non ionic and/or bi-ionic tensides.

As non ionic tensides, alkylalkoxylates, alkylesteralkoxylates, gluconamides and/or alkylpolyglycosides are particularly preferred.

The alylalkoxylates are preferably ethoxylized alcohols of preferably 8 to 22 C-atoms and preferably 1 to 80 EO units per alcohol molecule. The alcohol remnant is in linear position, or preferably in 2-position methyl ramified, or linear and containing methyl ramified remnants in the mixture, as is usual in oxy alcohol remnants. Among the preferred ethoxylized alcohols are for instance C₁₁-alcohols with 3, 5, 7, 8 and 11 EO units, (C₁₂-C₁₅) alcohols with 3, 5, 7, 8, 10 and 13 EO units, (C₁₄-C₁₅)-alcohol with 4, 7 and 8 EO units, (C₁₆-C₁₈)-alcohol with 8, 11, 15, 20, 25, 50 and 80 EO units and mixtures thereof. The ethoxyl levels stated represent statistical mean values and could translate for a specific product into whole or fractions of a number. In addition to these, fatty alcohol EO/PO derivatives can be used, as for instance ®Genapol types 3970, 2909 and 2822 by Clariant GmbH.

Further suitable tensides are polyhydroxy fatty acid amide by the formula R₂—CO—N(R₃)—Z, whereby R₂CO represents an aliphatic alkyl remnant with 6 to 22 carbon atoms, R₃ represents hydrogen, one alkyl or hydroxy alkyl remnant with 1 to 4 carbon atoms and Z represents a linear or ramified polyhydroxy alkyl remnant with 3 to 10 carbon atoms and 3 to 10 hydroxyl groups.

Preferred for use are alkyl glycosides by the general formula RO(G)ₓ, whereby R represents a primary straight chained or methyl ramified, particularly in 2-position methyl ramified, aliphatic remnant with 8 to 22, preferably 12 to 18 carbon atoms, and G represents one glycoside unit with 5 or 6 carbon atoms, preferably for glucose. For the oligomerization degree x, which specifies the distribution of monoglycosides and oligoglycosides a number between 1 and 10 is preferred, particularly preferred between 1.2 and 1.4.

Preferred for use are alkoxylized, preferably ethoxyl or ethoxyl and propoxyl compositions of fatty acid alkylester, preferably with 1 to 4 carbon atoms in the alkyl chain, particularly fatty acid methyl ester, as they are for instance described in the Japanese patent application JP 58/217598, or preferably those produced by the process as described in the international patent application WO A 90/13533.

Preferably, to be considered as ionic sulfonated tensides are the well known (C₉-C₁₃) alkyl benzol sulfonate, alpha olefin sulfonate and alkane sulfonate. Also suitable for use is ester of sulfonic fatty acids, the disalts of the alpha sulfonic fatty acids, respectively. Further suitable anionic tensides are sulfured fatty acid glycerin ester, which represent monoester, diester and triester, as well as mixtures thereof, as derived by esterification of 1 molecule monoglycerin with 1 to 3 molecules fatty acid or by esterification of triglycerides with 0.3 to 2 molecules glycerin. Particularly suitable as alkyl sulfates are sulfuric acid monoester of the (C₁₂-C₁₈) fatty alcohol, such as lauryl, myristate, cetyl or stearic alcohol and the fatty alcohol mixtures obtained from coconut oil, palm oil and palm kernel oil, which additionally may contain parts of unsaturated alcohol, for instance olein alcohol.

Soaps may also be used as anionic tensides. Suitable are saturated fatty acid soaps, such as salts of lauric acid, myristic acid, palmitic acid, stearic acid, hydrated erucic acid and especially those natural fatty acid soap mixtures derived from coconuts, palm kernels and tallow. The anionic tensides can be present in form of sodium- potassium- or ammonia salts, as well as soluble salts of organic base, such as mono- di- or triethanolamine. Preferably the anionic tensides are present as sodium or potassium salts, particularly as sodium salts.

Finally if need be, the detergent and cleaning agents may also contain enzymes, such as protease, amylase, lipase and cellulase.

The adjuncts according to this invention can also be employed as components in the production of compounds for detergents, cleaning agents, water softeners and modular detergent systems. It is possible to achieve special effects with compounds. It is, for instance, possible liquid components to be incorporated into powdered or tablet type detergents and cleaning agents. In this manner, coloration or speckling of detergents and cleanings agents can be accomplished.

Compounds of tensides with adjuncts according to the invention preferably contain

a) 70 to 99.5 weight-% of the adjunct according to the invention as granulate, [mean particle size of 200 to 2000 μm, preferably 300 to 900 μm, or in another preferred version as ground granulate, mean particle size of 0,1 to 300 μm, preferred 10 to 200 μm], and

b) 0.5 to 30 weight-% anionic, cationic, non ionic and/or bi-ionic tensides. Component a), as a granulate has a mean particle size of 200 to 2000 μm, preferably 300 to 900 μm, or in another preferred version as ground granulate, a mean particle size of 0.1 to 300 μm, preferred 10 to 200 μm. Preferred for use as tensides b) are the surface active compositions previously mentioned.

Another alternative preferred compound includes

a) 50 to 99 weight-% of the adjunct according to the invention,

b) 0.01 to 10 weight-% dyestuff; and

c) ad I 00 weight-% additional substances normally employed in the art of detergents and cleaning agents.

Preferred dyestuffs are oxidation resistant dyestuffs and/or pigments, particularly preferred are the ®Sandolan types (S. Blau E-HRL 180, S. NBG 125 (brilliant red),

S. MFBL (green) or also ®Vitasin types (V. ponceau 4RC82 (red), V. chinolingelb 70 (yellow) and ®Telon types (Telon Blau AFN, by DyStar Textilfarben). Pigments such as ®Patentblau (by DyStar), ®Unisperse types or ®Terasil-T types (both by Ciba) can be used also. The dye-stuffs can be applied as solutions or by dispersion.

Compounds with polycarboxylate copolymers comprise:

a) 70 to 90 weight-% of the adjunct according to the invention, and

b) 0.5 to 30 weight-% polycarboxylate copolymers

c) 0.5 to 30 weight-% water

When the adjunct is used in a compound along with a polycarboxylate, it is preferably in the form of a powder and has an average particle size of 1 to 500 μm, preferably 20 to 100 μm. Alternatively, the adjunct is in granulate form and has an average particle size of 200 to 2000 μm, preferred 300 to 900 μm.

Preferred for use as polycarboxylate copolymers b) are the previously mentioned acrylic acid maleic acid compositions.

Compounds with pH regulators comprise:

a) 60 to 99.5 weight-% of the adjunct according to the invention, and

b) 0,5 to 40 weight-% pH regulators

c) ad 100 weight-% additional substances normally employed in the art of detergents and cleaning agents.

When the adjunct is used in a compound along with a pH regulator, it is preferably in the form of a powder and has an average particle size of 1 to 500 μm, preferably 20 to 100 μm. Alternatively, the adjunct is in granulate form and has an average particle size of 200 to 2000 μm, preferred 300 to 900 μm.

Preferred for use as pH regulators b) are soda, potash, citric acid, sodium citrate and/or bicarbonate. It is preferred that the pH regulator have an average particle size of 0.1 to 4000 μm, most preferably, 20 to 200 μm. In an alternative preferred form, compounds used as granulate have an average particle size of 200 to 2000 μm, preferably 400 to 900 μm.

The compounds are produced either by agglomeration, grinding, kernel fractionation, etc. or by compacting, grinding, kernel fractionation, etc.

The detergent, cleaning agents, water softeners and modular components can be applied for instance as powders, granulates, gels, liquids or tablets. For the production of tablets, the specific composition is pressed into the desired shape by means of a tablet pressing device. This shape for instance can be cylindrical, quadratic, elliptic, ring shaped, or the like. In case of cylindrical shapes, the radius to height ratio can be between 0.1 to 10. The press pressure can be between 0.3 and 12 kN/cm². The geometric shape of the tablet is generally irrelevant for the press pressure.

Preferred press pressures to mold automatic dishwasher detergent into tablets range from 0.7 to 14.2 kN/cm², most preferably from 2.8 to 10 kN/cm².

To achieve more complex geometric shapes, the pressing procedure may involve several steps. For tablets consisting of several layers, any given portion of the compound can be pressed in sequence one on top of the other, resulting in several layers. In case of two layered tablets, the layer ratio between the two layers is preferably between 1:10 to 10:1.

Other applications are for instance tablets featuring inserted spherical compartments. The different layers and compartments of the tablets can also be marked by different coloring.

### EXAMPLES

The following examples are intended to further explain the invention and do not limit the spirit and scope of the present invention.

Determination of the phase composition of the crystalline layered sodium disilicate:

A mortared solid specimen is measured in an x-ray powder diffraction meter, Phillips PW 1710 (CuK alpha 2-rays, wave length 1,54439 Angström, acceleration voltage 35 kV, heat current 28 mA, Monochromator, scanning speed 3 degree 2 theta per minute). The intensities measured are evaluated as follows:

| Substance | characteristic peak (d-value in Angstrom) |
|---|---|
| Alpha-phase | 3.29 +/− 0,07, typical 3.31 |
| Beta-phase | 2.97 +/− 0.06 |
| Delta-phase | 3.97 +/− 0.08 |

The crystalline portions of the weight percent are calculated from the intensities Iₐ, I_{b} and I_{d} measured in impulses—of the alpha, beta and delta phases by the following formulas:

| | |
|---|---|
| Alpha-content: | A [%] = 100*Iₐ/(Iₐ + I_{b} + I_{d}) |
| Beta-content: | B [%] = 1,41*100I_{b}/(Iₐ + I_{d}) |
| Delta-content: | D [%] = 100 − A − D |

Should an analysis besides the crystalline parts also identify x-ray amorphous parts, the contents A, B, C have to be corrected by AM.

To determine the x-ray amorphous parts (AM), the base (impulses) of the x-ray peaks at a d-value of 2.65 Angström identified (Iₐₘ) and converted to the percentage value using the following empirical formula: AM [%]=(Iₐₘ-70)*100/450

Compacting, grinding and kernel fractionation of the builder compositions: The source material is moved by a transporting device (Stopfschnecke) between the rollers of a roller compactor (by Hosokawa-Bepex)-setting on level 5. The speed of this process creates a line pressure force of 2 to 200 kN/cm of roller width, preferably between 10 and 160 kN/cm roller width. Roller revolution speed is set on level 3 to 7, the gap between rollers is 0,1 mm. The resulting clumps (about 50 mm in length, thickness about 2 to 5 mm, width about 10 to 15 mm) are crushed in a hammer grinder (type UPZ by Alpine) the screen hole diameter of which is 5mm, with a revolution speed of 600 to 1400 U/pm. The crushed, powdery product is separated into oversized particles (screen hole diameter of 1000 μm) and undersized particles (screen hole diameter of 300 μm). The oversized particles are subjected to another grinding process and again screened. Both fractions with a particle size of between 300 μm and 1000 μm are then combined.

Determination of particle distribution in the builder compositions by screening analysis: A screening machine by Retsch is used for this process and screens of the desired size are inserted, whereby the mesh width of the screens is decreasing from top to bottom. 50 g of the powder to be analyzed is put on the spot where the screen is widest. By the swinging motion of the screening machine the powder material is transported through the various screens. The residues remaining on the screens are weighed and the material weight calculated. From these values, the d₅₀ value is then calculated.

Production of Test Detergent:

The optical brighteners are dissolved in a quarter of the molten alkylethoxylate. A household multipurpose mixer (by Braun) is used to mix half the quantity of the soda, bicarbonate, phosphate, respectively. In a plow-share mixer by Lödige, the remaining soda and the total quantity of the builder composition according to the invention, phosphate, zeolite, bicarbonate citric acid and polymer, respectively are mixed for 15 minutes at 300 revolutions/min. After that, the remaining half of the alkylethoxylate is sprayed on in 5 minutes. Finally, Alkan sulfonate, polyvinyl pyrrolidon, alkaline benzol sulfonate, soap, anti foaming agents, phosphonate, the compound containing optical brightener, are added mixed again for 10 minutes at 300 rev./min. The mixture is removed from the Lödige mixer and put in a tumble mixer having a low shearing force, where it is combined with the percarbonate, perborate, TAED and enzymes, respectively and mixed for another 5 minutes.

Tabletizing of Test Detergents:

A hydraulic press (type 3912 by Carver) is used for molding the basic detergent powder (consisting among others of linear alkyl benzol sulfonate, zeolite A, sodium carbonate, sodium sulfate, acrylic acid, maleic acid, copolymer, protease, optical brightener and fragrance) and disintegration system, if needed at a pressure of 180 to 185 psi into tablets of 2.25 inch diameter and weighing 40 g each.

Determination of Dissolution Speed:

A tablet is put in a 4 liter beaker to which 3 liter tap water, 150 ppm hardness, at 25 degree Celsius and the dissolution speed determined by recording the conductivity curve (type MC226, by Mettler). The solution is stirred at 355 rev./min. using a propeller stirrer, the blade having a 1 ¾ inch diameter is set to the 2 liter marking of the beaker. The dissolution speed is determined by the extent of disintegration occurring after 5 minutes. The ratio between the conductivity after 5 minutes and conductivity after reaching a plateau (after about 6 minutes) is expressed in percent.

Production of Automatic Dishwasher Detergent:

The solid components, with the exception of enzymes, bleaches and fragrance, are combined in a plow share mixer by Lödige and mixed well. Then the alkylethoxylate is sprayed on, and finally the enzymes, fragrance and bleach system mixed in.

### Example 1

In a share plow mixer by Lödige, 4.56 kg crystalline layered sodium disilicate (SKS-6 powder, Clariant GmbH) and 3.44 kg Acusol 771 by Rohm & Haas are combined to a powder mixture weighing 8 kg. This mixture is processed in a roller compactor at a line pressure of 16 kN/cm roller length, then ground and screened. The result is about 5.8 kg granulates of the proper size, from which the mean particle size d₅₀ and pouring density are determined (refer to table 1).

### Example 2

In a share plow mixer by Lödige, 5.12 kg crystalline layered sodium disilicate (SKS-6 powder, Clariant GmbH) and 2.88 kg Acusol 771 by Rohm & Haas are combined to a powder mixture weighing 8 kg. This mixture is processed in a roller compactor at a line pressure of 26 kN/cm roller length, then ground and screened. The result is about 5.5 kg granulates of the proper size, from which the mean particle size d₅₀ and pouring density are determined (refer to table 1).

### Example 3

In a share plow mixer by Lödige, 7,2 kg crystalline layered sodium disilicate (SKS-6 powder, Clariant GmbH) and 800 g Acusol 771 by Rohm & Haas are combined to a powder mixture weighing 8 kg. This mixture is processed in a roller compactor at a line pressure of 32 kN/cm roller length, then ground and screened. The result is about 5.5 kg granulates of the proper size, from which the mean particle size d₅₀ and pouring density are determined (refer to table 1).

### Example 4

In a share plow mixer by Lödige, 7.6 kg crystalline layered sodium disilicate (SKS-6 powder, Clariant GmbH) and 400 g Acusol 771 by Rohm & Haas are combined to a powder mixture weighing 8 kg. This mixture is processed in a roller compactor at a line pressure of 32 kN/cm roller length, then ground and screened. The result is about 1.84 kg granulates of the proper size (refer to table 1).

### Example 5 (comparison)

In a share plow mixer by Lödige, 7.2 kg crystalline layered sodium disilicate (SKS-6 powder, Clariant GmbH) and 800 g Sokolan CP-5 powder (a neutralized maleic acid/acrylic acid copolymerisate) by BASF are combined to a powder mixture weighing 8 kg. This mixture is processed in a roller compactor at a line pressure of 32 kN/cm roller length, then ground and screened. The result is only about 1.84 kg granulates of the proper size (refer to table 1). The granulate yield is considerably poorer than in the examples using Acusol 771.

### Example 6 (comparison)

In a roller compactor 8 kg crystalline layered sodium disilicate (SKS-6 powder by Clariant GmbH) are processed at a line pressure of 32 kN/cm roller length, then ground and screened. The result is about 5.2 kg granulates of the proper size (refer to table 1).

### Example 7 (comparison)

In a roller compactor 8 kg Acusol 771 by Rohm & Haas are processed at a line pressure of 32 kN/cm without receiving any granulates of the proper size (refer table 1). The granulating properties of pure Acusol 771 are therefore proven to be very much poorer than if mixed with crystalline layered sodium disilicate.

### Example 8 (comparison)

Basic detergent powder is pressed into detergent tablets and the degree of dissolution determined after 5 minutes.

### Example 9 (comparison)

A mixture of basic detergent powder and sodium acetate is pressed into detergent tablets and the degree of dissolution determined after 5 minutes.

### Example 10 (comparison)

A mixture of basic detergent powder and granulated crystalline layered sodium disilicate (SKS-6 granulate by Clariant GmbH is pressed into detergent tablets and the degree of dissolution determined after 5 minutes.

### Example 11 (comparison)

A mixture of basic detergent powder and Acusol 771 powder is pressed into detergent tablets and the degree of dissolution determined after 5 minutes.

### Example 12

A mixture of basic detergent powder and cogranulate from Example 3 is pressed into detergent tablets and the degree of dissolution determined after 5 minutes. The degree of dissolution is better than in Examples 8, 10 and 11.

### Example 13

A mixture of basic detergent powder and cogranulate from Example 1 is pressed into detergent tablets and the degree of dissolution determined after 5 minutes. The degree of dissolution is better than in Examples 8, 10, 11 and 12.

### Example 14 (comparison)

A mixture of basic detergent powder, Acusol 771 powder and sodium acetate is pressed into detergent tablets and the degree of dissolution determined after 5 minutes.

### Example 15 (comparison)

A mixture of basic detergent powder, Accusol 771 powder, granulated, crystalline layered sodium disilicate (SKS-6 granulate by Clariant GmbH) and sodium acetate is pressed into detergent tablets and the degree of dissolution determined after 5 minutes.

### Example 16

A mixture of basic detergent powder, cogranulate from Example 3 and sodium acetate is pressed into detergent tablets and the degree of dissolution determined after 5 minutes. The degree of dissolution is better than achieved in Examples 14 and 15.

### Example 17

A mixture of basic detergent powder, cogranulate from Example 3 and sodium acetate is pressed into detergent tablets and the degree of dissolution determined after 5 minutes. The degree of dissolution is better than achieved in Examples 14 and 15.

### Example 18

A mixture of basic detergent powder, cogranulate from Example 3 and sodium acetate is pressed into detergent tablets and the degree of dissolution determined after 5 minutes. The degree of dissolution is better than achieved in Examples 14 and 15.

### Example 19

A mixture of basic detergent powder, cogranulate from Example 3 and sodium acetate is pressed into detergent tablets and the degree of dissolution determined after 5 minutes. The degree of dissolution is better than achieved in Examples 14 and 15.

### Example 20

A mixture of basic detergent powder, cogranulate from Example 4 and sodium acetate is pressed into detergent tablets and the degree of dissolution determined after 5 minutes. The degree of dissolution is better than achieved in Examples 14 and 15.

### Example 21

A mixture of basic detergent powder, cogranulate from Example 1 and sodium acetate is pressed into detergent tablets and the degree of dissolution determined after 5 minutes. The degree of dissolution is better than achieved in Examples 14 and 15.

### Example 22

A mixture of basic detergent powder, cogranulate from Example 3 and sodium sulfate is pressed into detergent tablets and the degree of dissolution determined after 5 minutes. The degree of dissolution is better than achieved in Examples 14 and 15.

### Example 23

A mixture of basic detergent powder, cogranulate from Example 3 and ammonium sulfate is pressed into detergent tablets and the degree of dissolution determined after 5 minutes. The degree of dissolution is better than achieved in Examples 14 and 15.

### Example 24

A mixture of basic detergent powder, cogranulate from Example 3 and sodium citrate is pressed into detergent tablets and the degree of dissolution determined after 5 minutes. The degree of dissolution is better than achieved in Examples 14 and 15.

### Example 25

A mixture of basic detergent powder, cogranulate from Example 3 and sodium carbonate is pressed into detergent tablets and the degree of dissolution determined after 5 minutes. The degree of dissolution is better than achieved in Examples 14 and 15.

### Example 26 through 37

In accordance with the general regulations “Manufacturing of Test Detergents” and “Tabletizing of Detergents” detergent tablets are manufactured in compositions according to table 3.

### Examples 38 through 42

In accordance with the general regulation “Manufacturing of Dishwasher Detergents” test dishwasher detergents are manufactured in compositions as listed in table 4, and shaped into tablets at pressures from 0.7 to 14.2 kN/cm², preferably from 2.8 to 10 kN/cm².

### Example 43 through 44

In accordance with the general regulations “Manufacturing of Test Detergents” and “Tabletizing of Detergents” special detergent tablets are manufactured in compositions according to table 5.

| Chemicals used: | |
|---|---|
| ®Acusol 771 pdr | Fa. Rohm & Haas |
| AE 1 | ®Genapol OA 050, Fa. Clariant GmbH |
| AE 2 | ®Genapol 2822, Fa. Clariant GmbH |
| Alkyl sulfate | ®Sulfopon Fa. Cognis |
| Alkyl benzol sulfonate | ®Marlon ARL, Fa. Huls |
| Ammonium sulfate | Fa. Merck KGaA |
| Anti foaming agent | ®11 Plv ASP3, Fa. Wacker |
| Citric acid | Fa. Jungbunzlauer |
| CMC | ®Tylose 2000, Fa. Clariant GmbH |
| Enzyme 1 | ®Termamyl 60T, Fa. Solvay Enzymes |
| Enzyme 2 | ®Termamyl 120T, Fa. Solvay Enzymes |
| Enzyme 3 | ®Savinase 6.0 TW, Fa. Solvay En- |
| | zymes |
| Sodium layered silicate | ®SKS-6 gran, Fa. Clariant GmbH |
| NaDCC | Fa. Olin Chemicals |
| Sodium acetate th | Fa. Merck KGaA |
| Sodium bicarbonate | Fa. Solvay |
| Sodium carbonate | Heavy soda ash, company. Mat- |
| | thes & Weber |
| Sodium chloride | Fa. Merck KGaA |
| Sodium citrate dh | Fa. Jungbunzlauer |
| Sodium hydroxide | Microprills 100%, Fa. Riedel-de Haen |
| Sodium hypochlorite | Fa. Celanese GmbH |
| Sodium metasilicate ph | Fa. VanBaerle |
| Sodium perborate mh | Fa. Degussa |
| Sodium perborate th | Fa. Degussa |
| Sodium percarbonate | ®Oxyper C, Fa. Solvay Interox |
| Sodium phosphate 1 | Sodium tripolyphosphate, Fa. |
| | Thermphos Intl. |
| Sodium phosphate 2 | ®Makrophos 1018, Fa. BK Giulini |
| Sodium phosphate 3 | ®Thermphos NW coarse, Fa. Therm- |
| | phos Intl. |
| Sodium silicate amorph | ®3NaG, Modul 2,0, Fa. Clariant France |
| | SA |
| Sodium sulfate | Fa. Solvay |
| Optical brightener | ®Tinopal CBS-X, Fa. Ciba |
| Fragrance | lemon fragrance 781 22D, Fa Orissa |
| Phosphonate 1 | ®Dequest 2041, Fa. Monsanto |
| Phosphonate 2 | ®Dequest 200, Fa. Monsanto |
| Sodium copolymer 1 | ®Sokalan CP5 Pulver, Fa. BASF |
| Sodium copolymer 2 | ®Sokalan CP45, Fa. BASF |
| Sodium copolymer 3 | ®Sokalan CP5 liquid, Fa. BASF |
| Polyvinylpyrrolidone | ®Sokalan HP50, Fa. BASF |
| Soap | ®Liga basic soap HM11E |
| Soil release polymer | ®Texcare SRA-1 00, Fa. Clariant |
| | GmbH |
| TAED 1 | ®Peractive AN, Fa. Clariant GmbH |
| TAED 2 | ®Peractive AC White, Fa. Clariant |
| | GmbH |
| Zeolith A | ®Wessalith P, Fa. Degussa |

TABLE 1

| Examples | | 1 | 2 | 3 | 4 | 5 comp. | 6 comp. | 7 comp |
|---|---|---|---|---|---|---|---|---|
| SKS-6 Pdr | [wght.-%] | 57 | 64 | 90 | 95 | 90 | 100 | — |
| Acusol 771 | [wght.-%] | 43 | 36 | 10 | 5 | — | — | 100 |
| Sokalan CP5 | [wght.-%] | — | — | — | — | 10 | — | — |
| Line pressure | [kN/cm] | 16 | 26 | 32 | 32 | 32 | 32 | 32 |
| Cogranular | [%] | 72 | 68 | 66 | 70 | 23 | 65 | 0 |
| yield | | | | | | | | |
| Med. Particle | [my] | 321 | 358 | 491 | — | — | — | — |
| dia. d₅₀ | | | | | | | | |
| Bulk density | [g/L] | 562 | 640 | 851 | — | — | — | — |
| SKS-6 to | [−] | 1.33 | 1.78 | 9 | 19 | 9 | — | — |
| Polymer | | | | | | | | |
| Polymer to | [−] | 1 | 1 | 1 | 1 | 1 | — | — |
| Polymer | | | | | | | | |
| Soluble to | [−] | — | — | — | — | — | — | — |
| Polymer | | | | | | | | |

TABLE 2

| | | 8 | 9 | 10 | 11 | | | 14 | 15 | | | | | | | | | | |
|---|---|---|---|---|---|---|---|---|---|---|---|---|---|---|---|---|---|---|---|
| Examples | | comp. | comp. | comp. | comp. | 12 | 13 | comp. | comp. | 16 | 17 | 18 | 19 | 20 | 21 | 22 | 23 | 24 | 25 |
| Cogranular 3 | [wght.-%] | — | — | — | — | 30 | — | — | — | 10 | 10 | 10 | 5 | — | — | 10 | 10 | 10 | 10 |
| Cogranular 1 | [wght.-%] | — | — | — | — | — | 40 | — | — | — | — | — | — | — | 30 | — | — | — | — |
| Cogranular 4 | [wght.-%] | — | — | — | — | — | — | — | — | — | — | — | — | 10 | — | — | — | — | — |
| SKS-6 gran | [wght.-%] | — | — | 27 | — | — | — | — | 9 | — | — | — | — | — | — | — | — | — | — |
| Acusol 771 | [wght.-%] | — | — | — | 2.7 | — | — | 10 | 1 | — | — | — | — | — | — | — | — | — | — |
| pdr | | | | | | | | | | | | | | | | | | | |
| (SKS-6 via | [wght.-%] | — | — | — | — | 27 | 22.8 | — | — | 9 | 9 | 9 | 4.5 | 9.5 | 17.1 | 9 | 9 | 9 | 9 |
| Cogr.) | | | | | | | | | | | | | | | | | | | |
| (Polym via | [wght.-%] | — | — | — | — | 3 | 17.2 | — | — | 1 | 1 | 1 | 0.5 | 0.5 | 12.9 | 1 | 1 | 1 | 1 |
| Cogr.) | | | | | | | | | | | | | | | | | | | |
| Na-Acetate | [wght.-%] | — | 30 | — | — | — | — | 20 | 20 | 20 | 5 | 40 | 20 | 20 | 20 | — | — | — | — |
| th | | | | | | | | | | | | | | | | | | | |
| Na-Sulfate | [wght.-%] | — | — | — | — | — | — | — | — | — | — | — | — | — | — | 20 | — | — | — |
| NH₄-Sulfate | [wght.-%] | — | — | — | — | — | — | — | — | — | — | — | — | — | — | — | 20 | — | — |
| Na-Citrate | [wght.-%] | — | — | — | — | — | — | — | — | — | — | — | — | — | — | — | — | 20 | — |
| dh | | | | | | | | | | | | | | | | | | | |
| Na-Carbon- | [wght.-%] | — | — | — | — | — | — | — | — | — | — | — | — | — | — | — | — | — | 20 |
| ate | | | | | | | | | | | | | | | | | | | |
| Det Base | [wght.-%] | 100 | 70 | 73 | 97.3 | 70 | 60 | 70 | 70 | 70 | 85 | 50 | 75 | 70 | 50 | 70 | 70 | 70 | 70 |
| Powder | | | | | | | | | | | | | | | | | | | |
| Disintegra- | [%] | 7 | 6 | 3 | 9 | 21 | 43 | 55 | 40 | 83 | 63 | 87 | 73 | 65 | 99 | 69 | 79 | 74 | 64 |
| tion | | | | | | | | | | | | | | | | | | | |
| degree @ | | | | | | | | | | | | | | | | | | | |
| 5 min | | | | | | | | | | | | | | | | | | | |
| SKS-6 to | [−] | — | — | — | — | 9 | 1.3 | — | — | 9 | 9 | 9 | 9 | 19 | 1.3 | 9 | 9 | 9 | 9 |
| Polymer | | | | | | | | | | | | | | | | | | | |
| Polymer to | [−] | — | — | — | — | 1 | 1 | — | — | 1 | 1 | 1 | 1 | 1 | 1 | 1 | 1 | 1 | 1 |
| Polymer | | | | | | | | | | | | | | | | | | | |
| Soluble to | [−] | 1 | — | — | — | — | — | — | — | 20 | 5 | 40 | 40 | 40 | 1.6 | 20 | 20 | 20 | 20 |
| Polymer | | | | | | | | | | | | | | | | | | | |

TABLE 3

| | | | | | | | | | | | | |
|---|---|---|---|---|---|---|---|---|---|---|---|---|
| Examples | 26 | 27 | 28 | 29 | 30 | 31 | 32 | 33 | 34 | 35 | 36 | 37 |

| | | | | | | | | | | | | | |
|---|---|---|---|---|---|---|---|---|---|---|---|---|---|
| Cogranular 3 | [Gew.-%] | 10 | 10 | 10 | 10 | 10 | 10 | — | — | 10 | 10 | 10 | 10 |
| Cogranular 1 | [Gew.-%] | — | — | — | — | — | — | 3 | 5 | — | — | — | — |
| Na-Silicate am. | [Gew.-%] | — | — | — | — | — | — | — | — | 18 | — | — | — |
| Na-Carbonate | [Gew.-%] | 12 | — | — | 5 | 5 | 15 | 12 | 7.5 | 16 | 30 | 13 | 13 |
| Na-Sulfate | [Gew.-%] | — | 3 | 7 | 6.5 | 4 | 1 | 4.8 | 1 | 4.5 | — | — | 0.5 |
| Na-Bicarbonate | [Gew.-%] | — | 12 | — | — | — | — | — | — | — | — | — | — |
| Na-Citrate dh | [Gew.-%] | — | 7 | 5 | — | 3 | 5 | — | — | — | — | — | 2 |
| Na-Acetate th | [Gew.-%] | 6 | 10 | — | — | — | 9 | 7 | 16 | 3 | 7 | 16 | — |
| Citric acid | [Gew.-%] | — | 2 | — | — | — | 5 | — | — | — | | — | — |
| Na-Phosphate 1 | [Gew.-%] | — | — | — | — | — | — | — | — | — | — | — | 40 |
| Zeolite A | [wght.-%] | 30 | 30 | 20 | 25 | 15 | 14 | 25 | 25 | 6 | 25 | 28 | — |
| Na-Silicate layered | [wght.-%] | — | — | 15 | 10 | 26 | — | — | — | — | — | — | — |
| gran | | | | | | | | | | | | | |
| Na-Copolymer | [wght.-%] | 4 | 6 | 4 | 4 | 4 | 4 | 4 | 4 | 4 | 4 | 4 | — |
| Alkylbenzolsul- | [wght.-%] | 8 | 8 | 10 | 30 | — | 2 | 10 | 10 | 10 | 10 | 10 | 12 |
| fonate | | | | | | | | | | | | | |
| AE 1 | [wght.-%] | 4 | 4 | 25 | 7 | 18 | 2 | 5 | 10 | 10 | 10 | 10 | 4 |
| Alkylsulfate | [wght.-%] | — | — | — | — | — | 10 | 4 | — | — | — | — | — |
| Soap | [wght.-%] | 1 | 1 | — | — | 13 | 1 | 1 | — | 1 | 1.5 | 1.5 | — |
| Na-Perborate mh | [wght.-%] | 18 | — | — | — | — | — | 13 | — | — | — | 5 | — |
| Na-Percarbonate | [wght.-%] | — | — | — | — | — | 15 | — | 15 | 15 | — | — | 14 |
| TAED 1 | [wght.-%] | 4 | — | — | — | — | 4 | 6 | 4 | — | — | — | 2 |
| Phosphonate 1 | [wght.-%] | — | 0.2 | — | — | — | 0.5 | 0.2 | — | — | — | — | — |
| Enzyme 1 | [wght.-%] | 1 | 1.5 | 1.5 | 0.5 | 0.5 | 0.5 | 1.5 | 0.5 | 0.5 | 0.5 | 0.5 | 0.5 |
| Enzyme 3 | [wght.-%] | 0.5 | 1.5 | 1.5 | 0.5 | 0.5 | 0.5 | 1.5 | 0.5 | 0.5 | 0.5 | 0.5 | 0.5 |
| Opt. Brightener | [wght.-%] | 0.5 | — | — | 0.5 | — | — | 0.5 | 0.5 | 0.5 | 0.5 | 0.5 | 0.5 |
| Antifoam | [wght.-%] | 1 | 0.8 | 1 | 1 | 1 | 1 | 1 | 1 | 1 | 1 | 1 | 1 |
| Polyvinyl- | [wght.-%] | — | 1 | — | — | — | 0.5 | | — | — | — | — | — |
| pyrrolidone | | | | | | | | | | | | | |
| Soil release poly- | [wght.-%] | — | 1 | — | — | — | | 0.5 | — | — | — | — | — |
| mer | | | | | | | | | | | | | |
| CMC | [wght.-%] | — | 1 | — | — | — | — | — | — | — | — | — | — |
| SKS-6 to Polymer | [−] | 9 | 9 | 9 | 9 | 9 | 9 | 1.3 | 1.3 | 9 | 9 | 9 | 9 |
| Polymer to Polymer | [−] | 1 | 1 | 1 | 1 | 1 | 1 | 1 | 1 | 1 | 1 | 1 | 1 |
| Soluble to Polymer | [−] | 18 | 34 | 12 | 11.5 | 12 | 35 | 18.4 | 11.4 | 41.5 | 37 | 29 | 55.5 |

TABLE 4

| Examples | | 38 | 39 | 40 | 41 | 42 |
|---|---|---|---|---|---|---|
| Cogranular 1 | [wght.-%] | 5 | — | 5 | 5 | 3 |
| Cogranular 3 | [wght.-%] | — | 12 | — | — | — |
| Na-Acetate th | [wght.-%] | 16 | — | — | — | — |
| Na-Sulfate | [wght.-%] | — | 13 | — | — | — |
| Na-Citrate dh | [wght.-%] | — | — | 35 | — | — |
| Na-Metasilicate | [wght.-%] | — | — | — | — | 47 |
| ph | | | | | | |
| Na-Hydroxide | [wght.-%] | — | — | — | — | 8 |
| Na-Carbonate | [wght.-%] | 40 | 22 | 33 | 27 | 18 |
| Na-Phosphate | [wght.-%] | 35 | 35 | — | 47 | 20 |
| 2 | | | | | | |
| Na-Copolymer | [wght.-%] | — | — | 7 | 4 | — |
| Na-Percarbon- | [wght.-%] | — | — | 10 | — | — |
| ate | | | | | | |
| Na-Perborate | [wght.-%] | — | 10 | — | 10 | — |
| mh | | | | | | |
| Na-DCC | [wght.-%] | 2 | — | — | — | 1 |
| Na-DCC | [wght.-%] | 2 | — | — | — | 1 |
| TAED 2 | [wght.-%] | — | 3 | 5 | 2 | — |
| Enzyme 2 | [wght.-%] | — | 1.5 | 1.5 | 1.5 | — |
| Enzyme 3 | [wght.-%] | — | 1.5 | 1.5 | 1.5 | — |
| AE 2 | [wght.-%] | 2 | 2 | 2 | 2 | 3 |
| SKS-6 to | [−] | 1.33 | 9 | 1.33 | 1.33 | 1.33 |
| Polymer | | | | | | |
| Polymer to | [−] | 1 | 1 | 1 | 1 | 1 |
| Polymer | | | | | | |
| Soluble to | [−] | 42.3 | 58.3 | 31.6 | 34.4 | 72.1 |
| Polymer | | | | | | |

TABLE 5

| Examples | | 43 | 44 |
|---|---|---|---|
| Cogranular 3 | [wght.-%] | 34 | 10 |
| Na-Bicarbonate | [wght.-%] | 5 | — |
| Citric acid | [wght.-%] | 5 | — |
| Na-Sulfate | [wght.-%] | 5 | 20 |
| Na-Chloride | [wght.-%] | — | 2 |
| Na-Carbonate | [wght.-%] | — | 34 |
| Zeolite A | [wght.-%] | 40 | — |
| Na-Copolymer 1 | [wght.-%] | 7 | — |
| Na-Percarbonate | [wght.-%] | — | 21 |
| TAED 1 | [wght.-%] | — | 7 |
| Alkylbenzolsul- | [wght.-%] | — | 5 |
| fonate | | | |
| AE 1 | [wght.-%] | 2 | — |
| Soap | [wght.-%] | 2 | 1 |
| SKS-6 to Polymer | [−] | 9 | 9 |
| Polymer to Poly- | [−] | 1 | 1 |
| mer | | | |
| Soluble to Poly- | [−] | 16.2 | 56 |
| mer | | | |

1. A detergent disintegration adjunct comprising particles of at least one alkali layer silicate; and at least one water swellable component.

2. The detergent disintegration adjunct of claim 1, wherein said particles have an average particle of size greater than 200 μm and an average particle size of less than 2000 μm.

3. The detergent disintegration adjunct of claim 1, wherein said at least one alkali layer silicate is of the formula:
NaMSiₓO₂ₓ₊₁ x yH₂O,
wherein M represents sodium or hydrogen, x a number from 1.9 through 4, and y a number from 0 through 20.

4. The detergent disintegration adjunct of claim 3, wherein x is equal to 2,3, or 4.

5. The detergent disintegration adjunct of claim 1, wherein said at least one alkali layer silicate is a sodium disilicate.

6. The detergent disintegration adjunct of claim 1, wherein said at least one water swellable component is selected from the group consisting of cellulosics, polycarboxylic acids and the salts thereof, and cross-linked polycarboxylic acids and the salts thereof.

7. The detergent disintegration adjunct of claim 1, wherein said at least one water swellable component is a polycarboxylate.

8. The detergent disintegration adjunct of claim 1, wherein said at least one water swellable component is a crosslinked copolymer of acrylic and maleic acid.

9. A disintegration system for a detergent or cleaning agent comprising particles of:
1) at least one alkali layer silicate;
2) at least one water swellable component; and
3) at least one readily soluble, active detergent component.

10. The disintegration system of claim 9, wherein said at least one readily soluble, active detergent component is non-bleaching.

11. The disintegration system of claim 10, wherein said at least one readily soluble, non-bleaching active detergent component is selected from the group consisting of: alkali or ammonium carbonate, -hydrogencarbonate, carbonate salt mixtures, metasilicate, spray dried silicate, sulfate, hydrogensulfate, -halogenide, -phosphate, dihydrogen phosphate, hydrogen phosphate, polyphosphate, pyrophosphate, borate, Borax, organic acids and salts thereof, soluble organic compositions and hydrates thereof.

12. The disintegration system of claim 7, wherein said at least one alkali layer silicate is of the formula:
NaMSiₓO₂ₓ₊₁ x yH₂O,
wherein M represents sodium or hydrogen, x a number from 1.9 through 4, and y a number from 0 through 20.

13. The disintegration system of claim 8, wherein x is equal to 2, 3, or 4.

14. The disintegration system of claim 9, wherein said at least one alkali layer silicate is a sodium disilicate.

15. The disintegration system of claim 9, wherein said at least one water swellable component is selected from the group consisting of cellulosics, polycarboxylic acids and the salts thereof, and cross-linked polycarboxylic acids and the salts thereof.

16. The disintegration system of claim 9, wherein said at least one water swellable component is a polycarboxylate.

17. The disintegration system of claim 9, wherein said at least one water swellable component is a crosslinked copolymer of acrylic and maleic acid.

18. The disintegration system of claim 9, wherein the ratio between components 1) to components 2) is 0.5 to 1 to 20 to 1.

19. The disintegration system of claim 9, wherein the ratio between component 1) to component 2) to component 3) is 0.5 to 1 to 0.5 to 20 to 1 to 60.

20. A method of forming a disintegration system for detergent or cleaning agent comprising the steps of:
providing at least one alkali layer silicate and at least one water swellable component;
mixing said at least one alkali layer silicate and said at least one water swellable component to form a mixture; and
processing said mixture to form particles.

21. The method of claim 20, wherein said particles have a non-uniform morphology.

22. The method of claim 20, wherein said at least one alkali layer silicate is a sodium disilicate.

23. The method of claim 20, wherein said at least one water swellable component is a polycarboxylate.

24. The method of claim 20, wherein said at least one water swellable component is a crosslinked copolymer of acrylic and maleic acid.

25. The method of claim 20, further comprising providing at least one readily soluble, active detergent component and mixing said at least one readily soluble, active detergent component with at least one alkali layer silicate and at least one water swellable component to form said mixture.

26. The method of claim 25, wherein said at least one readily soluble, active detergent component is non-bleaching.

27. The method of claim 26, wherein said at least one readily soluble, active, non-bleaching detergent component is selected from the group consisting of: alkali or ammonium carbonate, -hydrogencarbonate, carbonate salt mixtures, metasilicate, spray dried silicate, sulfate, hydrogensulfate, -halogenide, -phosphate, dihydrogen phosphate, hydrogen phosphate, polyphosphate, pyrophosphate, borate, Borax, organic acids and salts thereof, soluble organic compositions and hydrates thereof.

28. A cogranulate comprising:
a) at least one crystalline layered sodium silicate of the formula NaMSiₓO₂ₓ₊₁*yH₂O. wherein M represents sodium or hydrogen, x represents a number from 1.9 to 4 and y a number from 0 to 20; and
b) at least one polycarboxylate;
wherein the ratio between components a) to b) is 0.5 to 1 to 20 to 1, and wherein said cogranulate is produced by contacting, mixing, roller compacting, grinding and kernel fractioning components a) and b).

29. A cogranulate disintegration system for detergent and cleaning agents comprising:
1) at least one crystalline layered sodium silicate a) of the formula NaMSiₓO₂ₓ₊₁ * yH₂O, wherein M represents sodium or hydrogen, x represents a number from 1.9 to 4 and y a number from 0 to 20;
2) at least one polycarboxylate b), wherein the ratio between components a) to b) is 0.5 to 1 to 20 to 1; and
3) at least one readily soluble, non bleaching active detergent substance c), wherein the ratio of component a) to component b) to component c) is 0.5 to 1 to 0.5 to 20 to 1 to 60., and
wherein said cogranulate disintegration system is produced by sequentially bringing in contact, mixing, roller compacting, grinding and kernel fractioning components a), b), and c).

30. The disintegration system of claim 29, further comprising at least one hardening agent.

31. The disintegration system of claim 30, wherein said at least one hardening agent is selected from the group consisting of alkali silicate,non ionic surfactant, anionic surfactant, cationic surfactant, polycarboxylate polymer, polycarboxylate copolymer, polyethylenglycol, bentonite, hectorite, saponite, and dye stuff.

32. A method of forming a cogranulate disintegration system for detergent and cleaning agent solids comprising the steps of:
providing at least one alkaline layered silicate and at least one polycarboxylate;
mixing said at least one alkaline layered silicate and said at least one polycarboxylate
roller compacting said mixture;
grinding said mixture; and
kernel fracturing said mixture to form particles.

33. The method of claim 32, wherein said mixing step is characterized by a mixing cycle of greater than 5 seconds and a mixing cycle of less than 60 minutes.

34. The method of claim 32, wherein said roller compacting step is accomplished at a temperature above 10° C. and a temperature below 200° C.

35. The method of claim 32, wherein said roller compacting step is characterized by a line pressure between 2 kN/cm and 200 kN/cm roller width.

36. The method of claim 32, wherein said particles have an average particle size of of 200 to 2000 μm.

37. A detergent or cleaning agent comprising:
a) 0.5 to 99 weight-% of adjunct particles, each adjunct particle comprising:
at least one alkali layer silicate, and
at least one water swellable component; and
b) 1 to 99.5 weight-% of at least one detergent component.

38. A composition comprising particles formed of at least one alkali layer silicate; and at least one water swellable component.

39. The composition of claim 38, wherein said at least one alkali layer silicate is of the formula:
NaMSiₓO₂ₓ₊₁ x yH₂O,
wherein M represents sodium or hydrogen, x a number from 1.9 through 4, and y a number from 0 through 20.

40. The composition of claim 39, wherein x is equal to 2,3, or 4.

41. The composition of claim 38, wherein said at least one alkali layer silicate is a sodium disilicate.

42. The composition of claim 38, wherein said sodium disilicate is crystalline layered sodium disilicate.

43. The composition of claim 42, wherein said crystalline layered sodium disilicate include the polymorphous phases alpha, beta, delta and epsilon.

44. The composition of claim 38, wherein said at least one water swellable component is selected from the group consisting of cellulosics, polycarboxylic acids and the salts thereof, and cross-linked polycarboxylic acids and the salts thereof.

45. The composition of claim 38, wherein said at least one water swellable component is a polycarboxylate.

46. The composition of claim 38, wherein said at least one water swellable component is a crosslinked copolymer of acrylic and maleic acid.
